(19) United States
(12) Patent Application Publication
(10) Pub. No.: US 2025/0185866 A1
(43) Pub. Date: Jun. 12, 2025

(54) USE OF FIDUCIAL MARKS BY A ROBOTIC VACUUM CLEANER

(71) Applicant: Dyson Technology Limited, Malmesbury, Wiltshire (GB)

(72) Inventors: Michael Laurence Carmine RAPICANO, Bristol (GB); William Henry KERR, Singapore (SG)

(21) Appl. No.: 18/846,346

(22) PCT Filed: Mar. 2, 2023
(86) PCT No.: PCT/GB2023/050480

§ 371 Date: Sep. 12, 2024

(30) Foreign Application Priority Data
Mar. 17, 2022 (GB) 2203730.3

(51) Int. Cl. A47L 11/40; A47L 9/28

(52) U.S. Cl. CPC A47L 11/4011; A47L 9/2873; A47L 11/4008; A47L 2201/022; A47L 2201/04

(57) ABSTRACT

A robotic vacuum cleaner system includes a robotic vacuum cleaner comprising a camera; and a processor including: a fiducial mark detecting module; a diagnostics module; and an alert generation module. The camera is configured to obtain an image of the surroundings of the robotic vacuum cleaner, and to transmit the obtained image to the processor. The fiducial mark detecting module is configured to: receive the image of the surroundings from the camera; and detect a fiducial mark on a robotic vacuum cleaner charging station in the image. The diagnostics module is configured to determine whether the image of the fiducial mark has predetermined expected characteristics, based on the image of the fiducial mark and additional information received by the diagnostics module. If the diagnostics module determines that the image of the fiducial mark does not have the predetermined expected characteristics, the alert generation module is configured to generate an alert.

### TECHNICAL FIELD OF THE INVENTION

The present invention relates to a robotic vacuum cleaner system which makes use of a fiducial mark or marks on a robotic vacuum cleaner charging station for diagnostic purposes.

### BACKGROUND TO THE INVENTION

Robotic vacuum cleaners often use fiducial marks to navigate themselves back to their docking or charging stations. It would be useful, however, to expand the uses of the fiducial marks.

### SUMMARY OF THE INVENTION

The inventors of the present invention have realized that the fiducial marks on a robotic vacuum cleaner charging station may be used for more than just guiding the robotic vacuum cleaner back to the robotic vacuum cleaner charging station after a cleaning operation. In particular, the present invention provides a robotic vacuum cleaner which is able to use the fiducial marks on an associated robotic vacuum cleaner charging station for diagnostic purposes. Specifically, a first aspect of the present invention provides a robotic vacuum cleaner system comprising: a robotic vacuum cleaner comprising a camera; and a processor comprising: a fiducial mark detecting module; a diagnostics module; and an alert generation module, wherein: the camera is configured to obtain an image of the surroundings of the robotic vacuum cleaner, and to transmit the obtained image to the processor; and the fiducial mark detecting module is configured to: receive the image of the surroundings from the camera; and detect a fiducial mark on a robotic vacuum cleaner charging station in the image; the diagnostics module is configured to determine whether the image of the fiducial mark has predetermined expected characteristics, based on the image of the fiducial mark and additional information received by the diagnostics module; and if the diagnostics module determines that the image of the fiducial mark does not have the predetermined expected characteristics, the alert generation module is configured to generate an alert.

By comparing the characteristics or properties of an image of a fiducial mark obtained by the camera, it is possible to diagnose possible issues with the robotic vacuum cleaner, the robotic vacuum cleaner charging station, or the surrounding environment, specifically when the characteristics do not match an expectation. This is explained in more detail later in the application. In the present application, the term “fiducial mark” is used to refer to a mark on a robotic vacuum cleaner charging station which may be used as a reference, and which is easily identifiable in an image, or in image data. More detailed characteristics of the fiducial marks are set out later in this application. Fiducial marks are typically used for navigation of robotic vacuum cleaners, but the inventors of the present invention have realized that the same fiducial marks may be used for diagnostic purposes.

The modules of the processor which are referred to above may be implemented as physical hardware modules. Alternatively, the modules may be implemented as functional, software modules, e.g. modules which are implemented in code. The alert may comprise a visual alert, e.g. a light, or flashing light. Alternatively, or additionally, the alert may comprise an audio alert, such as a sound which is played, e.g. a beep or buzz. In some cases, the robotic vacuum cleaner may comprise the processor, so that all of the processing steps discussed in this application take place on the robotic vacuum cleaner itself. Alternatively, the processor may be located on an external device such as a client device (e.g. a smartphone or other personal computing device), or a cloud computing server to which the robotic vacuum cleaner is configured to transmit the obtained information in order to determine e.g. the location and the presence/characteristics of the fiducial mark. The generated alert may be emitted from the robotic vacuum cleaner itself or by e.g. a user's personal computing device, so that the user is made aware of an issue even when not with the robotic vacuum cleaner during its cleaning operation.

It should be noted that the robotic vacuum cleaner system may comprise more than one camera. Furthermore, the one or more cameras may be configured to obtain a plurality of images. For example, at a given time, each camera of a plurality of cameras may be configured to obtain a respective image. Alternatively, each camera may be configured to obtain one or more respective images. Throughout this application, when it is stated that a given operation is executed e.g. based on “an obtained image”, or “the obtained image”, it should be understood that the same operation may be executed based on a plurality of obtained images too.

Herein, the “expected characteristics” of the image of the fiducial mark may comprise its location within the obtained image of the surroundings, and its shape within the obtained image of the surroundings (which is an indication of the orientation of the robotic vacuum cleaner relative to the fiducial mark, and therefore of the robotic vacuum cleaner charging station). The “expected characteristics” may also comprise the size of the fiducial mark within the obtained image of the surroundings, thereby providing an indication of the relative distance between the robotic vacuum cleaner and the fiducial mark on the robotic vacuum cleaner charging station. The “additional information” may comprise any information which defines or informs what the expected characteristics are at a given time. For example, the additional information may comprise the information that the robotic vacuum cleaner is being charged by or engaged with the robotic vacuum cleaner charging station, the location of the robotic vacuum cleaner at the time, a stage of a cleaning operation, or a time. It should be stressed that this is by no means an exhaustive list, though.

In cases where the expected characteristics refer to the location, shape, size, or other geometric characteristics of the fiducial mark within the obtained image, the diagnostics module may be configured quantitatively to determine a deviation from the expected characteristic or characteristics in question. In these cases, “expected characteristics” may be used interchangeably with e.g. “expected properties”, or “expected parameter values”, where the parameters define measurable properties of the image of the fiducial mark. Then, the diagnostics module may be configured to compare the determined deviation with a predetermined threshold deviation, which may be stored in a memory of the robotic vacuum cleaner. If it is determined that the determined deviation exceeds the predetermined threshold deviation, then the diagnostics module may be configured transmit instructions to the alert generation module, the instructions being configured to cause the alert generation module to generate an alert. In some, cases the diagnostics module of the processor may be configured to determine a deviation from the position of a fiducial mark in an obtained image and the expected position of the fiducial mark. Then, the diagnostics module may be configured to determine whether the deviation exceeds the predetermined threshold deviation (which may be stored in e.g. a memory of the robotic vacuum cleaner), and if so, the alert generation module may be configured to generate an alert, as outlined above.

In some cases, the robotic vacuum cleaner may be configured to engage with a robotic vacuum cleaner charging station in order to charge. In some cases, the robotic vacuum cleaner system may further comprise the robotic vacuum cleaner charging station, but it should be noted that in a broad example, the robotic vacuum cleaner system does not comprise the robotic vacuum cleaner charging system. Both arrangements are equally valid aspects of the invention.

The processor may comprise a charging detection module configured to determine when the robotic vacuum cleaner is being charged. Alternatively, or additionally, the robotic vacuum cleaner may comprise an engagement detection module configured to detect when the robotic vacuum cleaner is engaged with a robotic vacuum cleaner charging station (regardless of whether the device is charging, e.g. because the power to the robotic vacuum cleaner charging station is switched off). When the robotic vacuum cleaner is engaged with the robotic vacuum cleaner charging station, all things being well, the fiducial marks on the robotic vacuum cleaner charging station should be in a predetermined location, relative to the robotic vacuum cleaner. Any deviation from this predetermined relative location may be an indicator that there is a fault with the robotic vacuum cleaner charging station, that the robotic vacuum cleaner is improperly aligned with the robotic vacuum cleaner charging station, or that the robotic vacuum cleaner charging station has been improperly assembled. This kinds of faults or misalignments preferably give rise to an alert. In order to achieve this, when either the charging module detects that the robotic vacuum cleaner is being charged by the robotic vacuum cleaner charging station or the engagement detection module detects that the robotic vacuum cleaner is engaged with the robotic vacuum cleaner charging station, the diagnostics module may be configured to determine whether the fiducial marks are located in an 20 expected position in the image.

If, when the robotic vacuum cleaner is in a charging position, or otherwise engaged with a robotic vacuum cleaner charging station, and the fiducial detection module or the diagnostics module determines that the fiducial marks are either not present in the image received from the camera or are not present in an expected location in an image received from the camera, the robotic vacuum cleaner may be configured to generate an alert indicating that the robotic vacuum cleaner is improperly assembled, e.g. that the backplate of the charging station is not properly connected to the rear engagement region of the dock.

In a particular arrangement, the robotic vacuum cleaner charging station is separable into two or more components. In such cases, detection by the diagnostics module of the processor that the image of the fiducial mark does not have the expected characteristics may be indicative of the fact that the components of the robotic vacuum cleaner charging station have not been properly assembled.

Specifically, when the robotic vacuum cleaner is in a charging position (e.g. as detected by the charging detection module), or otherwise engaged with a robotic vacuum cleaner charging station (e.g. as detected by the engagement detection module), and the fiducial detection module or the diagnostics module determines that the fiducial marks are either not present in the image received from the camera or are not present in an expected location in an image received from the camera, the robotic vacuum cleaner may be configured to generate an alert indicating that the backplate of the charging station is not properly connected to the rear engagement region of the dock.

We now discuss the characteristics of the separable robotic vacuum cleaner charging station in more detail. The robotic vacuum cleaner charging station may comprise a dock and a planar backplate, wherein the black plate is separably connected to an engagement portion of the dock by means of engagement between a first connector on the engagement portion and a second connector on the backplate. Specifically, the engagement portion may comprise a front engagement region having a first electrical contact configured to engage with a complementary second electrical contact on the robotic vacuum cleaner. The dock may further comprise a base arranged, in use, to contact a floor. The backplate is preferably planar, having a front surface comprising the second connector, and a rear surface. The fiducial marks are preferably located on the planar backplate, preferably on the front surface thereof. Preferably, there are two fiducial marks on the backplate. The fiducial marks preferably include a pattern of black and white regions. Preferably, the fiducial mark includes four square regions arranged into a larger square, the four square regions alternately coloured black and white. The backplate is preferably rectangular (or square shaped), with a top edge of the backplate arranged in use to be parallel to the floor. In such cases, a first fiducial mark is preferably located at a first top corner of the backplate, and a second fiducial marks is preferably located at a second top corner of the backplate, the first top corner opposite the second top corner.

As discussed, the robotic vacuum cleaner charging station may be separable into the dock and the backplate. Herein, “separably” means that it is possible to separate the backplate from the dock. The term may be used interchangeably with e.g. “reversibly”, “removably”, “detachably”. Even though the connection is separable, it is preferred that there is some kind of locking engagement which enables the two components to be fixed together. The locking engagement may be provided by e.g. a frictional force between the first connector and the second connector, which can be overcome with a sufficient separating force.

Herein, the term “connector” is used to refer to a feature which enables the joining of two components together. The first connector and the second connector are preferably complementary to each other. Herein, “complementary” means that the first connector and the second connector are preferably engaged, or engageable with, each other. In other words, when the two components are connected, they are locked or held in place, or otherwise secured together, albeit reversibly (i.e. not permanently). In some cases, the first connector may be a first mechanical connector and the second connector may be a second mechanical connector, i.e. the connectors may be engageable with each other by virtue of their geometry, and optionally moving features. Alternatively, or additionally, the first connector may be a first magnetic connector and the second connector may be a second magnetic connector, i.e. the connectors may be engageable with each other as a result of an attractive magnetic force between the two. In some cases, the connectors may be mechanical and magnetic. Other mechanisms of engagement between the first connector and the second connector are also envisaged: the invention is not limited only to mechanical and magnetic engagement. The first connector may comprise a recess, and the second connector may comprise a projection. Alternatively, the first connector may comprise a projection and the second connector may comprise a recess. In each case, the recess may be configured to receive the projection.

The rear engagement region of the dock may comprise a plurality of first connectors, and the front surface of the backplate may comprise a plurality of second connectors, wherein the backplate is separably connected to the engagement portion of the dock by means of engagement between each first connector with a respective second connector. As with the plurality of electrical contacts, engagement by means of a plurality of connectors ensures a more stable engagement, and may act to limit undesirable rotation, which could cause damage to the connectors. In implementations in which there are a plurality of first connectors and a plurality of second connectors, all of the first connectors may comprise projections, and all of the second connectors may comprise recesses, configured to receive the projections. Or, all of the first connectors may comprise recesses, and all of the second connectors may comprise projections, the recesses configured to receive the projections. In other cases, the plurality of first connectors may comprise a mixture of projections and recesses, with the plurality of second connectors comprising a complementary mixture of projections and recesses.

The backplate of the robotic vacuum cleaner charging station is planar. Herein, the term “planar” may mean that the entirety of the backplate is planar or substantially planar, or flat. The term may also encompass a component, a significant majority of which is planar or substantially planar. It is required that the backplate have a front surface and a rear surface. The terms “front” and “rear” herein refer to the location of the surface when the robotic vacuum cleaner charging station is in normal use. In a usage configuration, the base (specifically, a lower surface of the base) is preferably facing downwards and engaged with a floor of the building. In some implementations, the base may be separable from the engagement portion in a similar manner to the backplate being separable from the backplate.

In use, and when the backplate is engaged with the dock by virtue of engagement between the first connector and the second connector, the plane of the backplate is preferably perpendicular or substantially perpendicular to the base. Preferably, the plane of the backplate is vertically or substantially vertically upright when the base is engaged with the floor as outlined above. In such cases, the rear surface of the backplate is preferably arrange, in use, to contact a vertical wall, e.g. an internal wall of a building. However, in some cases, the robotic vacuum cleaner charging station need not be up against a wall. The surfaces of the backplate are referred to as a “front surface” and a “rear surface”. In the context of the invention, a “forward” direction is the direction out of the plane of the backplate towards the dock (i.e. out from the front surface), and a “backward” or “rear-facing” direction is the opposite (or substantially opposite) direction. The term “lateral” may be used to refer to sideways (i.e. left-right) directions.

A robotic vacuum cleaner charging station is a component which may be connected to a robotic vacuum cleaner in order to charge its battery. Accordingly, the dock may be configured to receive a supply of electrical current, for example from the mains electricity, or from an external battery. The dock is may be configured to receive the electric current via a wire, cable, or other electrical connector. In other cases, the robotic vacuum cleaner may comprise its own power supply, e.g. a battery, preferably a rechargeable battery. In order to operate as a robotic vacuum cleaner charging station, it must be able to convey the electrical current to the robotic vacuum cleaner itself. Accordingly, the first electrical contact may be configured to convey electrical current to the robotic vacuum cleaner is engaged with the complementary second electrical contact, thereby charging the robotic vacuum cleaner. It should be noted that the robotic vacuum cleaner charging station of the first aspect of the invention preferably does not include the robotic vacuum cleaner itself, and therefore the complementary second electrical contact preferably does not form part of the invention. In later aspects of the invention, kits and systems are provided which do include the robotic vacuum cleaner.

The rear engagement region may comprise or be in the form of a planar wall arranged to face the front surface of the backplate. Or, when the dock is engaged with the backplate, the planar wall of the front engagement portion may face the front surface of the backplate. The presence of two planar surfaces facing each other helps to minimize the overall form factor of the assembled robotic vacuum cleaner charging station. In such cases, the dock may be configured to receive the supply of electrical current via a cable from an external power source, and the planar rear wall of the rear engagement portion may include a groove arranged to receive the cable. By providing a groove in which the cable may reside when the robotic vacuum cleaner charging station is assembled, it is possible to ensure that the front surface of the backplate and the planar wall forming the rear of the rear engagement portion rest flush against one another, again reducing the form factor of the assembled robotic vacuum cleaner charging station. Alternatively, the front surface of the backplate may include the groove, with equivalent benefits achieved. Preferably, the groove extends to one or both of the lateral edges of the planar wall of the rear engagement portion. In this way, the cable can emerge from a side of the assembled robotic vacuum cleaner charging station, while the two planar faces are flush together. In other cases, the backplate may have a hole formed therein, the hole preferably formed in a location corresponding to a location of a charging port on the rear engagement portion, so that an electrical connector at one end of the cable may be connected to a charging port on the rear engagement port even when the robotic vacuum cleaner charging station is assembled.

The groove may comprise one or more cable-retaining features configured to prevent the cable from inadvertently exiting the groove. The cable-retaining features may be features of the geometry of the groove, or may comprise e.g. lips, clips, hooks, or other formations arranged to keep the cable in place in the groove.

The front engagement region of the dock may comprise a plurality of first electrical contacts, configured to engage with a respective plurality of second electrical contacts on the robotic vacuum cleaner. The use of a plurality of electrical contacts ensures improved stability when the robotic vacuum cleaner is engaged with the charging station, which itself may reduce the risk of damage to the electrical contacts of either the robotic vacuum cleaner or the charging station. Preferably, front engagement region includes two first electrical contacts configured to engage with two respective electrical contacts on the robotic vacuum cleaner. The robotic vacuum cleaner charging station may comprise a front-facing planar surface, and the first electrical contact or the plurality of first electrical contacts may be located on the front-facing planar surface. The plane of the front-facing planar surface is preferably perpendicular to a plane of the base of the dock, such that it is vertical or substantially vertical in use. In implementations in which there are two electrical contacts, the two electrical contacts are preferably laterally spaced from each other, with a first electrical contact being located near a first lateral edge of the planar wall, and a second electrical contact being located at a second lateral edge of the planar wall, the first lateral edge being opposite the second lateral edge.

We now discuss some structural features of the robotic vacuum cleaner charging station which enable it to engage with the robotic vacuum cleaner. At a high level, in addition to the electrical contacts, the robotic vacuum cleaner charging station (specifically, the front engagement region thereof) is preferably shaped to conform to the robotic vacuum cleaner. The front engagement region may further comprise a laterally extending recess arranged to receive a front portion of the robotic vacuum cleaner. Herein, “laterally-extending” should be understood to mean that the recess runs in a lateral direction as explained earlier. Preferably, the laterally extending recess extends across the full lateral extent of the front engagement region, i.e. it has no side walls. The laterally-extending recess preferably has a constant cross-section, i.e. it may be prismatic. The cross-section may be quadrant-shaped, or substantially quadrant-shaped, where “quadrant” is used herein to refer to a quarter-circle, or a quarter-ellipse. The geometry of the front portion of the robotic vacuum cleaner is preferably complementary to the geometry of the laterally-extending recess, i.e. an inversion thereof, so that the front portion of the robotic vacuum cleaner is configured to rest closely or tightly in the laterally-extending recess. Such conforming geometry may enable a more stable engagement between the first electrical contact(s) and the second electrical contact(s), and may also aid in docking of the robotic vacuum cleaner with the robotic vacuum cleaner charging station. In the above, the plurality of first connectors may consist of two first connectors, and the plurality of second connectors may consist of two second connectors.

In some implementations, the base may extend past a rear wall of the engagement portion. The portion of the base which extends past may form a lip or ledge. In such cases, the first connector (or plurality thereof) may be located on this portion. Rather than being on a front surface of the backplate, in these cases, a bottom surface of the backplate may comprise include the second connector (or plurality thereof). As above, the first and second connectors may comprise one or more projections and complementary recesses. In these cases, in order to assemble the robotic vacuum cleaner, the backplate may be engaged with the lip or ledge in a vertical direction. This may be advantageous in that it would prevent the two components from becoming inadvertently separated by movement in a forward-backward direction.

The processor may further comprise a location detection module, which is configured to determine the location of the robotic vacuum cleaner in the building. In some cases, the location determination module may be configured to determine the location of the robotic vacuum cleaner in the building based on one or more obtained images from the camera(s). The location determination unit may be used in combination with the fiducial marks to enable the robotic vacuum cleaner to navigate back to the robotic vacuum cleaner charging station after a cleaning operation has been completed, or when e.g. a rechargeable power source of the robotic vacuum cleaner is running low. For example, the robotic vacuum cleaner may comprise a memory storing a map of a floor of the building, the map including an indication of the location of the charging station, and a motion system. The processor may further comprise a navigation module, and in a return operation, the navigation module may be configured to determine a route back from a current location of the robotic vacuum cleaner towards the charging station, and to generate instructions, which when received by the motion system, cause it to move the robotic vacuum cleaner towards the charging station. The location determination module may be further configured to determine, based on a determined location of the robotic vacuum cleaner and the map of the floor of the building, when the robotic vacuum cleaner is located within a predetermined threshold distance of the charging station. And, the fiducial detection module may be configured to detect the presence of the one or more fiducial marks on the charging station when it is determined that the robotic vacuum cleaner is within the predetermined threshold distance of the charging station. The predetermined threshold distance may be, for example, 0.5 to 2 metres.

The fiducial mark or marks may have a diagnostic purpose in this context, as well as detecting whether or not the robotic vacuum cleaner charging station is correctly assembled.

When it is determined that the robotic vacuum cleaner is located within the predetermined threshold distance of the robotic vacuum cleaner charging station, the one or more cameras may be configured to obtain one or more images of the surroundings of the robotic vacuum cleaner in its location. Thereafter, the fiducial detection module may be configured to detect whether the fiducial mark on the robotic vacuum cleaner charging station is present in an image obtained by the camera(s). Alternatively, or additionally, the fiducial detection module (or, indeed, the diagnostics module) may be configured to determine whether the fiducial marks are in an expected location or have an expected shape in the obtained one or more images. Specifically, if the fiducial marks are not present, or are in an unexpected location (or an unexpected orientation), then this may be an indication that the robotic vacuum cleaner charging station has been moved, or obscured by another item. In the positive case, when it is determined that the fiducial marks are present in the image obtained by the one or more cameras, the fiducial detection module is configured to determine relative position information indicating a position of the robotic vacuum cleaner relative to the charging station; and the navigation module is configured to: determine a route from the current location of the robotic vacuum cleaner to a charging position in which the robotic vacuum cleaner is engaged with the charging station, based on the relative position information, and generate instructions, which when received by the motion system, cause it to move the robotic vacuum cleaner to the charging position.

In the converse case, however, when it is determined that the fiducial mark is not present in the obtained one or more images, or doesn't have the expected characteristics (e.g. location, shape, size, or other geometric feature), the navigation module may be configured to identify an alternative position within the predetermined threshold distance of the charging station. The navigation module may be further configured to determine a route from the current location of the robotic vacuum cleaner to the alternative position within the predetermined threshold distance of the charging station. The navigation module may be further configured to generate instructions, which when received by the motion system, cause it to move the robotic vacuum cleaner to the alternative position within the predetermined distance threshold of the charging station. And, when it is determined that that robotic vacuum cleaner is located at the alternative position within the predetermined threshold distance of the charging station, the one or more cameras may be configured again to obtain one or more images of the surroundings of the robotic vacuum cleaner in its location. Thereafter, the fiducial detection module may again be configured to detect whether the fiducial mark on the robotic vacuum cleaner charging station is present in an image obtained by the camera(s). Alternatively, or additionally, the fiducial detection module (or, indeed, the diagnostics module) may again be configured to determine whether the fiducial marks are in an expected location or have an expected shape in the obtained one or more images. Then, if the fiducial marks are again not present, or are in an unexpected location (or an unexpected orientation), then this may be an indication that the robotic vacuum cleaner charging station has been moved, or obscured by another item. In this case, the process may be repeated until the robotic vacuum cleaner has maneuvered into a position in which it is determined that the fiducial mark is present in an image obtained by the one or more cameras, and the image thereof has the expected characteristics. This process of selecting an alternative position and reassessing whether the fiducial mark is present and/or assessing whether the image thereof has the expected characteristics may be performed a predetermined number of times. After that, if a positive determination is not made, the alert generation module may be configured to generate an alert. Alternatively, the robotic vacuum cleaner, the processor may be configured to cause the robotic vacuum cleaner to shut down, or to enter a low power mode.

In some cases, the alert may be generated after a single determination that the fiducial marks are absent, or the image thereof doesn't display the expected characteristics. Alternatively put, when it is determined (e.g. by the fiducial detection module or the diagnostics module) that the fiducial mark is not present in the one or more obtained images, or when it is determined (again, e.g. by the fiducial detection module or the diagnostics module) that the image (or portion of the image) of the fiducial mark does not have the expected characteristics, the alert generation module may be configured to generate an alert. As discussed previously, in order to cause the alert generation module to generate the alert, the processor (e.g. the diagnostics module or fiducial detection module) may be configured to generate and transmit instructions to the alert generation module, the instructions configured to cause the alert generation module to generate the alert.

The diagnostic processes carried out based on the fiducial mark may take place during a return operation, i.e. when the robotic vacuum cleaner is returning to the robotic vacuum cleaner charging station after a cleaning operation. Alternatively, however, the process may take place at the beginning of a cleaning operation. Specifically, at the start of a cleaning operation, when the robotic vacuum cleaner is located in the charging position in which it is engaged with the robotic vacuum cleaner charging station (or shortly after), the fiducial detection module (or the diagnostics module) may be configured to determine either whether a fiducial mark is present in one or more images obtained by the one or more cameras, or whether the obtained image of a fiducial mark has the expected characteristics (as explained previously, with reference to location, shape, size etc.). If the result of the determination is a negative one, i.e. if the fiducial detection module (or the diagnostics module) determines either that a fiducial mark is not present in one or more images obtained by the one or more cameras, or that the obtained image of a fiducial mark does not have the expected characteristics, the alert generation module of the robotic vacuum cleaner may be configured to generate an alert as outlined previously. In some cases, the robotic vacuum cleaner will then not carry out the cleaning operation. Alternatively, the robotic vacuum cleaner may be configured still to carry out the cleaning operation.

The first aspect of the invention relates to a robotic vacuum cleaner system. A second aspect of the invention provides a method, which may be executed by the robotic vacuum cleaner system of the first aspect of the invention. Specifically, the second aspect of the invention may provide a diagnostic method performed by a robotic vacuum cleaner system, the method comprising: obtaining an image of surroundings of a robotic vacuum cleaner; detecting a fiducial mark on a robotic vacuum cleaner charging station in the obtained image; determining whether the image of the fiducial mark has predetermined expected characteristics, based on the image of the fiducial mark and additional information; and if it is determined that the image of the fiducial mark does not have the predetermined expected characteristics, generating an alert. The optional features which have been set out above with reference to the first aspect of the invention apply equally well to the second aspect of the invention, except where clearly incompatible, or where context clearly dictates otherwise. It should be stressed that in all cases, the device features may well be converted to method features. We set out some of the key features below, but it should be noted that this is by no means an exhaustive list.

Obtaining an image of the surroundings of the robotic vacuum cleaner may comprise obtaining a plurality of images.

The step of determining may comprise determining quantitatively a deviation of a value of characteristic of the fiducial mark from the obtained image from an expected value of the characteristic; comparing the determine deviation to a predetermined deviation threshold; and if it is determined that the determined deviation exceeds the predetermined threshold deviation, generating the alert.

The method may further comprise determining that the robotic vacuum cleaner is engaged with and/or being charged by a robotic vacuum cleaner charging station. Then, if it is detected that the fiducial marks are either not present in the obtained image or do not have the expected characteristics, the generated alert may indicate that a robotic vacuum cleaner charging station is not properly assembled. The discussion of the structure of the robotic vacuum cleaner charging station, set out in respect of the first aspect of the invention, applies equally well here.

The method may further comprise determining the location of the robotic vacuum cleaner in the building based on the obtained image(s). The method may further comprise determining a route back from a current location of the robotic vacuum cleaner towards the robotic vacuum cleaner charging station, and generating instructions which when received by a motion system of the robotic vacuum cleaner, cause the motion system to move the robotic vacuum cleaner towards the robotic vacuum cleaner charging station.

The method may further comprise determining when the robotic vacuum cleaner is located within a predetermined threshold distance of the charging station. In such cases, when it is determined that the robotic vacuum cleaner is located within a predetermined threshold distance of the robotic vacuum cleaner charging station, the method may further comprise detecting the presence of the fiducial mark(s). The method may also further comprise, when it is determined that the robotic vacuum cleaner is located within the predetermined threshold distance of the robotic vacuum cleaner charging station, obtaining an image of the surroundings of the robotic vacuum cleaner in that location, and determining whether the fiducial mark is present in an obtained image. Additionally, or alternatively, the method may further comprise determining whether the fiducial marks are in an expected location or have expected shape in the obtained one or more images.

When it is determined that the fiducial marks are present in the image obtained by the one or more cameras, the method may comprise determining relative position information indicating a position of the robotic vacuum cleaner relative to the robotic vacuum cleaner charging station. The method may further comprise determining a route from the current location of the robotic vacuum cleaner to a charging position in which the robotic vacuum cleaner is engaged with the charging station, based on the relative position information. The method may further comprise generating instructions, which when received by the motion system, cause it to move the robotic vacuum cleaner to the charging position.

In the converse case, however, when it is determined that the fiducial mark is not present in the obtained one or more images, or doesn't have the expected characteristics (e.g. location, shape, size, or other geometric feature), the method may further comprise identifying an alternative position within the predetermined threshold distance of the charging station. The method may then further require determining a route from the current location of the robotic vacuum cleaner to the alternative position within the predetermined threshold distance of the charging station. As before then method may further comprise generating instructions, which when received by the motion system, cause it to move the robotic vacuum cleaner to the alternative position within the predetermined distance threshold of the charging station. And, when it is determined that that robotic vacuum cleaner is located at the alternative position within the predetermined threshold distance of the charging station, the method may again further comprise obtaining one or more images of the surroundings of the robotic vacuum cleaner in its location. Thereafter, the method may comprise detecting whether the fiducial mark on the robotic vacuum cleaner charging station is present in the obtained image(s). Alternatively, or additionally, the method may further comprise determining whether the fiducial marks are in an expected location or have an expected shape in the obtained one or more images. Then, if the fiducial marks are again not present, or are in an unexpected location (or an unexpected orientation), then this may be an indication that the robotic vacuum cleaner charging station has been moved, or obscured by another item. In this case, the process may be repeated until the robotic vacuum cleaner has maneuvered into a position in which it is determined that the fiducial mark is present in an obtained image, and the image thereof has the expected characteristics.

This process of selecting an alternative position and reassessing whether the fiducial mark is present and/or assessing whether the image thereof has the expected characteristics may be performed a predetermined number of times. After that, if a positive determination is not made, the method may proceed to generating an alert. Alternatively, the method may further comprise shutting down the robotic vacuum cleaner, or entering a low power mode.

In some cases, the alert may be generated after a single determination that the fiducial marks are absent, or the image thereof doesn't display the expected characteristics. Alternatively put, when it is determined (e.g. by the fiducial detection module or the diagnostics module) that the fiducial mark is not present in the one or more obtained images, or when it is determined (again, e.g. by the fiducial detection module or the diagnostics module) that the image (or portion of the image) of the fiducial mark does not have the expected characteristics, the method may comprise generating an alert at that point. Generating an alert may comprise generating and transmitting instructions to an alert generation module, the instructions configured to cause the alert generation module to generate the alert.

The method of the second aspect of the invention may take place at the beginning of a cleaning operation. Specifically, at the start of a cleaning operation, when the robotic vacuum cleaner is located in the charging position in which it is engaged with the robotic vacuum cleaner charging station (or shortly after), the method may comprise determining either whether a fiducial mark is present in one or more images obtained by the one or more cameras, or whether the obtained image of a fiducial mark has the expected characteristics (as explained previously, with reference to location, shape, size etc.). If the result of the determination is a negative one, i.e. if it is determined either that a fiducial mark is not present in one or more images obtained by the one or more cameras, or that the obtained image of a fiducial mark does not have the expected characteristics, the method may then comprise generating an alert as outlined previously. In some cases, the robotic vacuum cleaner will then not carry out the cleaning operation. Alternatively, the robotic vacuum cleaner may still carry out the cleaning operation.

The invention includes the combination of the aspects and preferred features described except where such a combination is clearly impermissible or expressly avoided.

### BRIEF DESCRIPTION OF THE DRAWINGS

Embodiments of the present invention will now be described with reference to the accompanying drawings, in which:

FIG. 1 is a perspective view of a robotic vacuum cleaner charging station.

FIG. 2 is a rear view of a dock of a robotic vacuum cleaner charging station.

FIG. 3 is an exploded view of the robotic vacuum cleaner charging station.

FIG. 4 shows a robotic vacuum cleaner engaging with a charging station.

FIG. 5 shows an alternative view of the robotic vacuum cleaner.

FIG. 6 is a schematic diagram of a robotic vacuum cleaner system including a client device, a robotic vacuum cleaner, and a robotic vacuum cleaner charging station.

FIG. 7 is a flowchart illustrating a process which may be performed by a robotic vacuum cleaner system.

FIG. 8 is a flowchart illustrating a process which may be performed by a robotic vacuum cleaner system.

FIG. 9 is a flowchart illustrating a process which may be performed by a robotic vacuum cleaner system.

FIG. 10 is a flowchart illustrating a process which may be performed by a robotic vacuum cleaner system.

### DETAILED DESCRIPTION OF THE DRAWINGS

Aspects and embodiments of the present invention will now be discussed with reference to the accompanying figures. Further aspects and embodiments will be apparent to those skilled in the art. All documents mentioned in this text are incorporated herein by reference.

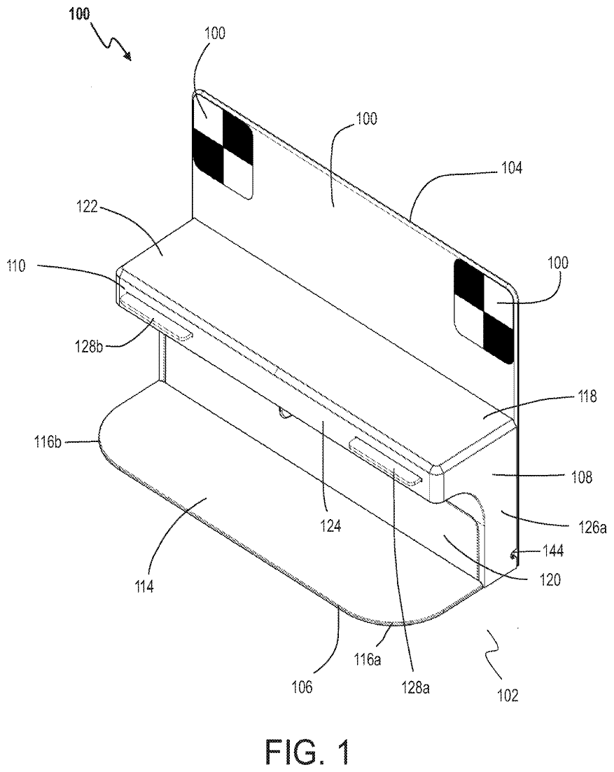

FIGS. 1 to 3 each show a perspective view of a robotic vacuum cleaner charging station 100 according to the first aspect of the invention. The charging station 100 includes a dock 102, and a backplate 104. The dock 102 includes a base 106 and an engagement portion 108. The engagement portion 108 includes a front engagement region 110 and a rear engagement region 112. Each of these components will now be described in more detail with reference to FIGS. 1 to 3.

The dock 102 comprises the base 106 and engagement portion 108. In the example shown, the base 106 is planar. In the example shown in FIGS. 1 to 3, the base 106 does not extend underneath the engagement portion 108, but in other cases it may do so, i.e. the engagement portion 108 may rest on the base 106. In some cases, the term “base” may be used to refer to the planar element 114 shown in FIGS. 1 to 3, but alternatively, the term may refer to the whole underside of the dock 102. The base 106, in the form of the planar element 114 is substantially rectangular, having rounded front corners 116a, 116b. The engagement portion 108 is in the form of a substantially cuboidal block 118 having a prismatic cut out, forming a laterally-extending recess 120. The cuboidal block 118 has a top surface 122, side (or lateral) surfaces 124a, 124b, front surface 124, and rear surface 126. In the example show, the edges of the cuboidal block 118 are beveled for a smoother appearance. Front surface 124 does not extend the full height of the cuboidal block 118 because of the laterally-extending recess 120 which is cut out from the block 118. The cross-section of the prismatic cut out in the engagement portion 108 is approximately quadrant-shaped, or rectangular with a rounded corner.

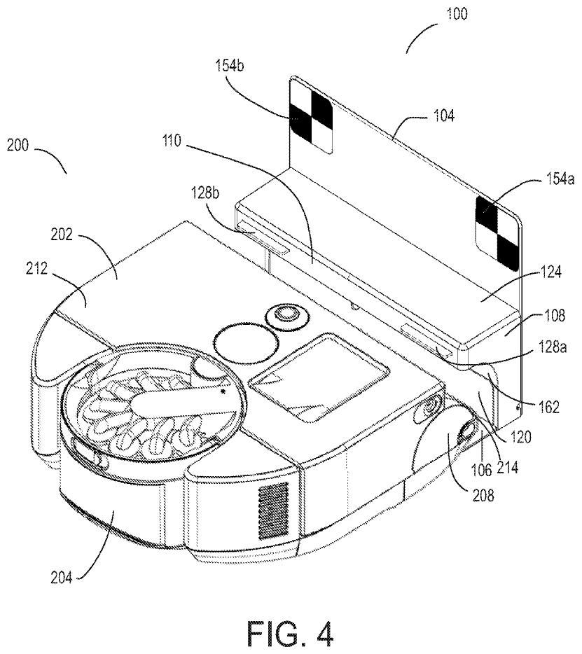

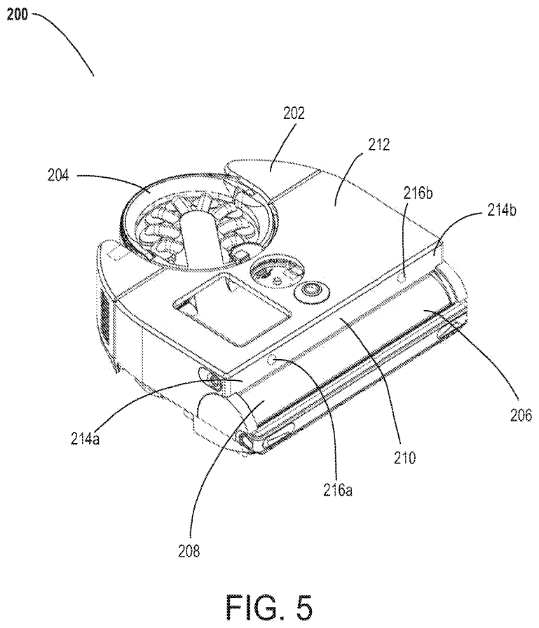

At each end of the front surface 124 is an electrical contact 128a, 128b. These electrical contacts 128a, 128b are in the form of elongate projections, which are approximately rectangular, having rounded front corners. They are arranged to be received by corresponding recesses on the robotic vacuum cleaner (discussed in more detail with reference to FIGS. 4 and 5). In some cases, the electrical contacts 128a, 128b may be spring loaded such that they protrude from the dock 102 when the robotic vacuum cleaner is not charging, and are compressed into the dock 102 when charging is taking place.

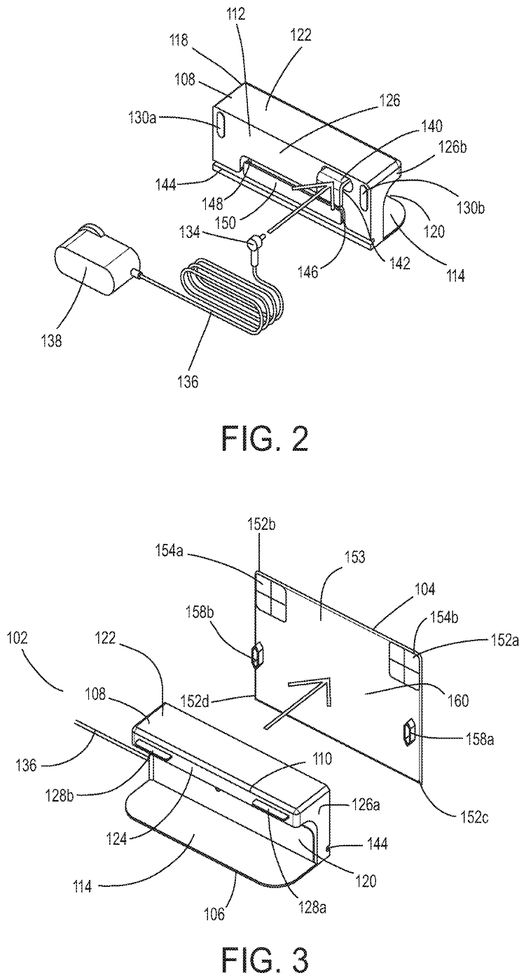

FIG. 2 shows the rear surface 126 of the engagement portion 108 more clearly. The rear surface 126 is substantially rectangular. At each of the top corners there is a first connector 130a, 130b. In the example shown, the first connectors 130a, 130b are in the form of elongate, vertically extending recesses in the rear surface 126 of the engagement portion 108. The engagement portion 108 is the component to which the robotic vacuum cleaner connects in order to charge. Accordingly, it is configured to connect to a power supply. The engagement portion 108 is configured to receive the power supply via assembly 132, which comprises an electrical contact 134, cable 136, and plug 138. The plug 138 is arranged to plug into a power outlet (not shown). Rear surface 126 of the engagement portion 108 includes an electrical port (not visible) arranged to receive the electrical contact 134. In order to ensure that the electrical contact 134 does not protrude from the rear surface 126 (thereby preventing the backplate 104 from sitting flush against it), the electrical port is located in a recess 140, having a depth equal to or greater than the depth in the forward-backward direction of the electrical contact 134. The rear surface 126 of the engagement portion 108 also includes a recessed cable retaining portion 142 which comprises a straight groove 144 and a cable winding portion 146, both of which are recessed from the rear surface 126 of the engagement portion 108. The winding portion 146 comprises a channel 148 defining a central island 150 which is connected to the straight groove 144. When the electrical contact 134 is pressed into the electrical port in the recess 140, the cable 136 may then be wound around the island 150, and placed in the straight groove 144, and then emerge from the engagement portion 108 in one of the side surfaces 124a, 124b. As discussed earlier in this application, the purpose of this is to ensure that the backplate 104 is able to sit flush with the rear surface 126 of the engagement portion 108, without being spaced as a result of the presence of the cable 136.

The backplate 104 is a substantially rectangular component with rounded corners 152a, 152b, 152c, 152d, having a front surface 153 and a rear surface (not visible). Near each of the top two corners 152a, 152b is a fiducial mark 154a, 154b, in the form of four squares arranged in a 2×2 formation to form a larger square, with the squares alternately coloured black and white for maximum contrast. Close to lateral edges 156a, 156b, and approximately halfway up the front surface 153 there are second connectors 158a, 158b, in the form of elongate projections. In order to assemble the robotic vacuum cleaner charging station 100, the second connectors 158a, 158b are inserted into first connectors 130a, 130b, thereby joining the backplate 104 to the dock 102. The backplate 104 also includes a hole 160. The hole 160 enables a light on the back of the dock 102 to be visible when the backplate 104 is connected.

We now discuss the engagement of the charging station 100 with robotic vacuum cleaner 200. FIG. 5 shows an example of a robotic vacuum cleaner 200 in detail. The details of the robotic vacuum cleaner 200 are beyond the scope of this application, so our description focuses on the parts of the robotic vacuum cleaner 200 which are relevant for engagement with the charging station 100. Robotic vacuum cleaner 200 includes a main body portion 202, an airflow generation assembly 204 and a brush bar 206. The details of the airflow generation assembly 204 are not relevant for the purposes of this application other than to note that it is located at a rear end 208 of the robotic vacuum cleaner 200. The brush bar 206 comprises an enclosure 208 in the form of a hemispherical prism. Inside the enclosure 208 (not shown), there is a rotating brush which is configured to contact the floor, thereby agitating dust particles and lifting them from the floor so that they can be entrained in an airflow generated by the airflow generation assembly 204. A lower edge 210 of the enclosure 208 is spaced from the floor, to enable air to enter the enclosure 208. Above the enclosure 208, there is a planar front surface 210 which is approximately perpendicular to a top surface 212 of the main body 202 of the robotic vacuum cleaner 200. At either end 214a, 214b of the planar front surface 210, there is an electrical contact 216a, 216b.

FIG. 4 shows the robotic vacuum cleaner 200 in a position where it is about to engage with the charging station 100. When engaged, the electrical contacts 216a, 216b engage with electrical contacts 128a, 128b in order to charge the battery of the robotic vacuum cleaner 200. It will be noted that, when the robotic vacuum cleaner 200 engages with the charging station 100, i.e. when the electrical contacts 216a, 216b engage with electrical contacts 128a, 128b, the front portion 214 of the enclosure 208 of the brush bar 206 rests within the laterally-extending recess 120. The curvature of the corner 162 of the laterally-extending recess 120 approximately matches the curvature of the front portion 214 of the enclosure 208 to ensure a snug fit, and a compact appearance.

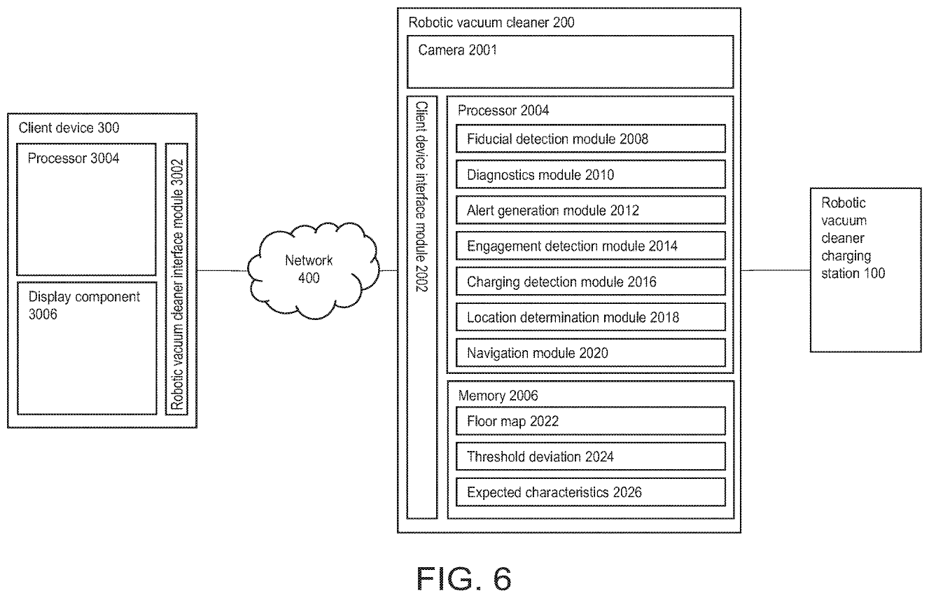

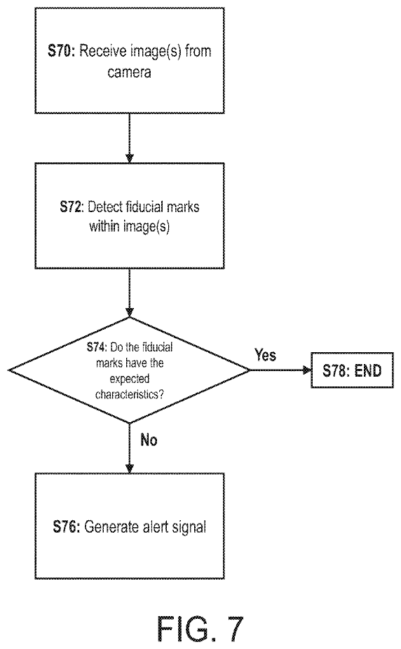

To illustrate the advantages of the present invention, FIGS. 6 and 7 show the charging station 100 in place in packaging. In the images, the top surface 122 and the electrical contacts 128a, 128b are visible, as well as part of the base 106. From this, it will be appreciated that the dock 102 is standing upright as it would in use, within the box 300. If the charging station 100 were not separable, as in the present invention, then it will be appreciated that the backplate would have to emerge upwards out of the box, from behind the rear surface 126 of the dock 102. However, in the arrangement shown, the backplate 104, separated from the dock 102 is laid down in the box 300 with its plane substantially parallel to the plane of the base 106. This enables the size of the box 300 to be reduced, reducing the required amount of packaging materials. This is beneficial in terms of transporting the packaged goods, because more boxes 300 can fit within a given volume. The reduction in packaging materials also has a clear environmental benefit. It will be noted that additional moulded regions 302 and 304 are formed to contain the robotic vacuum cleaner 200 and plug 138 respectively.

Having discussed the structural aspects of the robotic vacuum cleaner system including the robotic vacuum cleaner 200 and the robotic vacuum cleaner charging station 100, we now discuss the functional aspects. FIG. 6 is a schematic view of a robotic vacuum cleaner system including the robotic vacuum cleaner charging station 100, the robotic vacuum cleaner 200, and a client device 300. In FIGS. 6, various functional modules of the robotic vacuum cleaner 200 and the client device 300 are shown. The robotic vacuum cleaner 200 and the client device 300 are in communication with each other, for example via a network 400. Network 400 is preferably a wireless network, such as a Wi-Fi network or a cellular network. In other cases, though, the client device 300 may be connected to the robotic vacuum cleaner 200 via a wireless connection such as a connection relying on electromagnetic waves, e.g. an RF connection, or an infrared connection.

The robotic vacuum cleaner 200 comprises a camera 2001, a client device interface module 2002, a processor 2004, and a memory 2006. The processor 2004 may comprise several functional modules including: a fiducial detection module 2008, a diagnostics module 2008, an alert generation module 2010, an engagement detection module 2014, a charging detection module 2016, a location determination module 2018, and a navigation module 2020. The operation of each of these modules is discussed later in this application. The memory 2006 of the robotic vacuum cleaner 200 may store data representing: a floor map 2022, a threshold deviation 2024, and expected characteristics 2026.

The client device 300 may comprise: a robotic vacuum cleaner interface module 3002, a processor 3004, and a display component 3006.

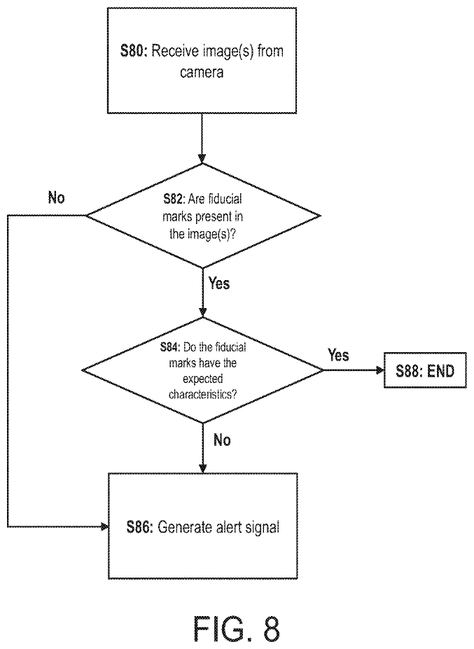

We now discuss the operation of the components shown in FIG. 6, specifically to perform various diagnostic tests based on detection of fiducial marks (or absence thereof). FIG. 7 is a flowchart showing a high-level diagnostic process which may be executed by a robotic vacuum cleaner 200. It should be noted that the process shown in FIG. 7 is performed by the various functional modules of the processor 2004 of the robotic vacuum cleaner. Prior to the process of FIG. 7, the camera 2001 may obtain one or more images of the surroundings of the robotic vacuum cleaner 200. It should be noted that, as discussed earlier in this application, the robotic vacuum cleaner 200 may comprise more than one camera 2001. The camera(s) 2001 may be in the form of a 2D camera or a 3D camera. After the camera 2001 has obtained the image(s), it is configured to send them to the processor 2004. At this point, in step S70, the processor 2004, specifically the fiducial detection module 2008 thereof receives the image(s) from the camera 2001. Subsequently, in step S72, the fiducial detection module 2008 is configured to detect one or more fiducial marks in the received image(s). In the process of FIG. 7, it is assumed that one or more fiducial marks are present in the image(s). We discuss with reference to FIG. 8 the process in which no fiducial marks are detection. In step S74, the diagnostics module 2010 may determine whether the fiducial marks have the expected characteristics. Specifically, in step S74 the diagnostics module 2010 may determine whether the portion of the obtained image(s) containing a fiducial mark has the expected characteristics. Alternatively, the diagnostics module 2010 may determine whether an image of the fiducial mark has the expected properties, e.g. if a region of the image containing the fiducial mark is extracted. Alternatively, the diagnostics module 2010 may determine whether the obtained image as a whole has the expected characteristics, particularly with reference to the fiducial mark or marks shown in the image. The determination whether the fiducial mark(s) has the expected characteristics is based on the obtained images and additional information. The nature of the additional information is explained elsewhere in this application. As also explained previously, the diagnostics module may quantitatively determine a deviation from the expected characteristic or characteristics in question. Then, the diagnostics module may compare the determined deviation with the predetermined threshold deviation 2204, which is stored in a memory 2006 of the robotic vacuum cleaner 200. If it is determined that the fiducial mark(s) do have the expected characteristics, based on the obtained images and the additional information, then the process ends in step S78. If not, and a deviation is detected in some way, then the alert generation module 2012 may generate an alert in step S76. Specifically, in this case, the diagnostics module 2010 may generate instructions which, when received and/or executed by the alert generation module 2012, cause it to generate an alert. In some cases, the alert generation module 2012 may be configured to generate instructions, which when executed by processor 3004 of the client device 300, cause the client device 300 either to display an alert on display component 3006, or otherwise alert a user (e.g. by a sound) that an issue has been detected. The alert generation module 2012 may then be configured to transmit the instructions to the client device via client device interface module 2002, and the instructions may be received by the client device 300 via the robotic vacuum cleaner interface module 3002, at which point they may be executed by the processor 3004.

FIG. 8 shows a slightly different process, in which there is a “two-step” test. As with the previous drawing, in step S80, the processor 2004, specifically the fiducial detection module 2008 receives the image(s) from the camera 2001. Then, in step S82, it is determined by the fiducial detection module 2008 (or alternatively by the diagnostics module 2010) whether the fiducial marks are present in the obtained image(s). If it is determined that there are no fiducial marks present (when it is expected that they should be), then the process proceeds to step S86, in which an alert is generated by the alert generation module 2012. This may happen in the same manner as was described in the previous paragraph. If the fiducial detection module 2008 does detect a fiducial mark(s) in the obtained image(s), in step S84, the diagnostics module 2010 may determine whether the fiducial marks have the expected characteristics, in the same manner as above. If it is determined that the fiducial mark(s) do have the expected characteristics, based on the obtained images and the If additional information, then the process ends in step S88. not, and a deviation is detected in some way, then the alert generation module 2012 may generate an alert in step S86, again in the same manner as described in the previous paragraph. In some cases, the method of FIG. 8 may take place at the beginning of a cleaning operation. The cleaning operation may still continue after the alert is generated. Alternatively, rather than generating the alert initially, after step S84, it may perform the cleaning operation, and then navigate back to or towards the robotic vacuum cleaner charging station 100, at which point the alert generation module 2012 may generate the alert.

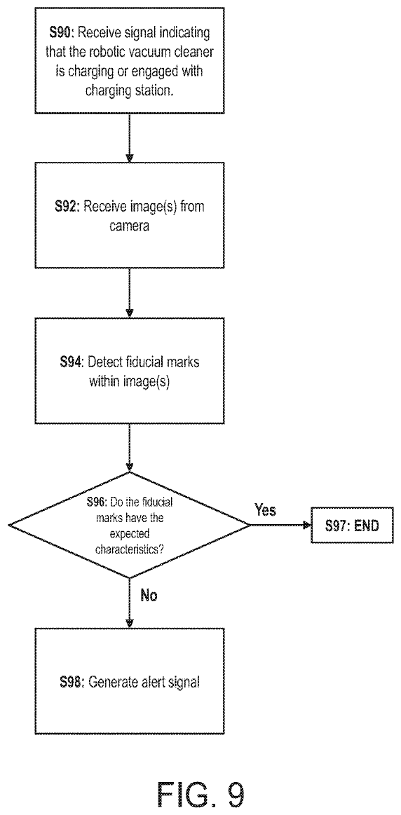

FIG. 9 shows a similar process in which fiducial marks are used to determine whether the robotic vacuum cleaner charging station 100 as shown in FIGS. 1 to 4 is assembled correctly. Firstly, it is determined that the robotic vacuum cleaner 200 is engaged with the robotic vacuum cleaner charging station 100. Specifically, either the engagement detection module 2014 may detect engagement between the robotic vacuum cleaner 200 and the robotic vacuum cleaner charging station 100, or the charging detection module 2016 may detect that the robotic vacuum cleaner 200 is being charged, from which it is possible to infer that it is engaged with the robotic vacuum cleaner charging station 100 in a charging position. The engagement detection module 2014 or the charging detection module 2016 may generate a signal in response to a determination that the robotic vacuum cleaner 200 is engaged with and/or being charged by the robotic vacuum cleaner charging station 100. This signal may be transmitted to the camera(s) 2001, which may then be configured to obtain image(s) of the surroundings of the robotic vacuum cleaner 200. In some cases, only an image which is directed towards the region of the surroundings where the fiducial mark is expected to be may be obtained. This is because, when the robotic vacuum cleaner 200 is engaged with the robotic vacuum cleaner charging station 100, it may be assumed that the fiducial mark(s) is visible and not obscured (since a docking process generally requires the use of the fiducial mark(s)). In step S92, the fiducial detection unit 2008 may be configured to detect the fiducial mark(s) within the obtained image(s), as before. Then, in step S94, the diagnostics module 2010 may determine whether the fiducial marks have the expected characteristics, in the same manner as above. In this case, the intention is to determine whether the backplate 104 of the robotic vacuum cleaner charging station 100 is correctly connected to the dock 102 of the robotic vacuum cleaner charging station 100. If the two components 102, 104 are not correctly assembled, then the location of the fiducial mark(s) in the obtained image may deviate from an expected location, or an orientation of the fiducial mark(s) relative to the robotic vacuum cleaner 200 may be different from an expected orientation (which may manifest itself in the fiducial mark(s) appearing a different shape, or a different size). In step S84, the diagnostics module 2010 therefore preferably determines whether the image(s) of the fiducial mark(s) show the expected location, size, and/or shape characteristics, based on the additional information that the robotic vacuum cleaner 200 is engaged with and/or being charged by the robotic vacuum cleaner charging station 100. If it is determined by the diagnostics module in step S96 that the image of the fiducial mark(s) do have the expected characteristics, then the process may end in step S97. Otherwise, in step S98, an alert may be generated by the alert generation module 2012 as outlined previously.

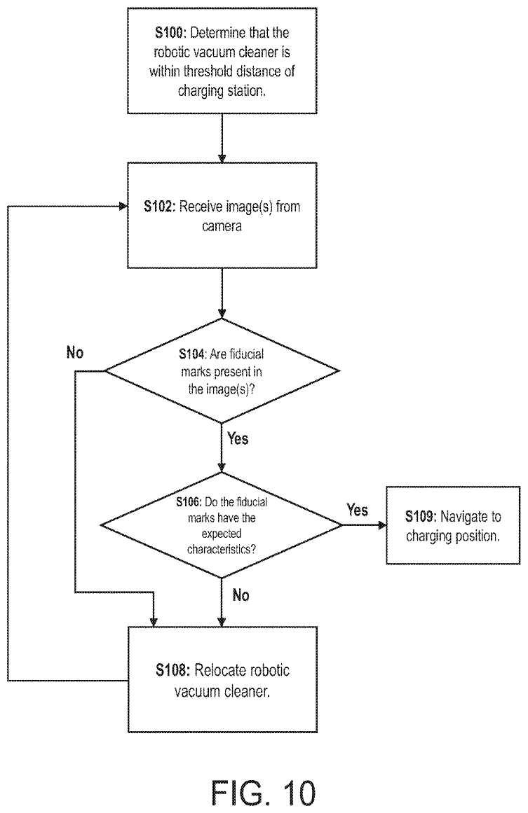

FIG. 10 shows a process in which fiducial marks are used to inform a docking process. After a cleaning operation, the robotic vacuum cleaner 200 may be returning to the robotic vacuum cleaner charging station 100. When the location determination module 2018 detects in step S100 that the robotic vacuum cleaner 200 is within a threshold distance of the robotic vacuum cleaner charging station 100, based on e.g. an image obtained from the camera 2001, or by referring to floor map 2022, a further image(s) may be obtained by the camera(s) 2001, or the already-obtained image(s) may be transmitted to the fiducial detection module 2008, and be received in step S102. Then, as before in step S104, it is determined by the fiducial detection module 2008 (or alternatively by the diagnostics module 2010) whether the fiducial marks are present in the obtained image(s). If it is determined that there are no fiducial marks present (when it is expected that they should be), then the process proceeds to step S108, in which the robotic vacuum cleaner 200 manoeuvres to a different position within the threshold distance to the robotic vacuum cleaner charging station 100. If, in step S104 the fiducial detection module 2008 does detect a fiducial mark(s) in the obtained image(s), in step S106, the diagnostics module 2010 may determine whether the fiducial marks have the expected characteristics, in the same manner as outlined earlier in this application. above. Then, like when it is determined that the fiducial mark(s) are not present, when it is determined that the fiducial mark(s) does not show the expected characteristics, the process proceeds to step S108, in which the robotic vacuum cleaner 200 manoeuvres to a different position within the threshold distance to the robotic vacuum cleaner charging station 100 in step S108. When it is determined that the fiducial mark(s) does have the expected characteristics, in step S109, the robotic vacuum cleaner 200, specifically the navigation module 2020 thereof may navigate the robotic vacuum cleaner 200 to a charging position in which it is engaged with the robotic vacuum cleaner charging station 100, using conventional methods (e.g. determining a next movement step based on a location of the fiducial within an obtained image). Steps S102 to S108 may be performed a predetermined number of times, e.g. 2, 3, 4, 5, 6, 7, 8, 9, or 10 times. After the predetermined number of iterations, it may be determined that there is a problem, and an alert may be generated, as in previous examples.

The features disclosed in the foregoing description, or in the following claims, or in the accompanying drawings, expressed in their specific forms or in terms of a means for performing the disclosed function, or a method or process for obtaining the disclosed results, as appropriate, may, separately, or in any combination of such features, be utilised for realising the invention in diverse forms thereof.

While the invention has been described in conjunction with the exemplary embodiments described above, many equivalent modifications and variations will be apparent to those skilled in the art when given this disclosure. Accordingly, the exemplary embodiments of the invention set forth above are considered to be illustrative and not limiting. Various changes to the described embodiments may be made without departing from the spirit and scope of the invention.

For the avoidance of any doubt, any theoretical explanations provided herein are provided for the purposes of improving the understanding of a reader. The inventors do not wish to be bound by any of these theoretical explanations.

Any section headings used herein are for organizational purposes only and are not to be construed as limiting the subject matter described.

Throughout this specification, including the claims which follow, unless the context requires otherwise, the word “comprise” and “include”, and variations such as “comprises”, “comprising”, and “including” will be understood to imply the inclusion of a stated integer or step or group of integers or steps but not the exclusion of any other integer or step or group of integers or steps.

It must be noted that, as used in the specification and the appended claims, the singular forms “a,” “an,” and “the” include plural referents unless the context clearly dictates otherwise. Ranges may be expressed herein as from “about” one particular value, and/or to “about” another particular value. When such a range is expressed, another embodiment includes from the one particular value and/or to the other particular value. Similarly, when values are expressed as approximations, by the use of the antecedent “about,” it will be understood that the particular value forms another embodiment. The term “about” in relation to a numerical value is optional and means for example +/−10%.

1. A robotic vacuum cleaner system comprising:
a robotic vacuum cleaner comprising a camera; and
a processor comprising:
a fiducial mark detecting module;
a diagnostics module; and
an alert generation module,
wherein:
the camera is configured to obtain an image of the surroundings of the robotic vacuum cleaner, and to transmit the obtained image to the processor; and
the fiducial mark detecting module is configured to: receive the image of the surroundings from the camera; and detect a fiducial mark on a robotic vacuum cleaner charging station in the image;
the diagnostics module is configured to determine whether the image of the fiducial mark has predetermined expected characteristics, based on the image of the fiducial mark and additional information received by the diagnostics module; and
if the diagnostics module determines that the image of the fiducial mark does not have the predetermined expected characteristics, the alert generation module is configured to generate an alert.

2. The robotic vacuum cleaner system according to claim 1, wherein:
the robotic vacuum cleaner comprises the processor.

3. The robotic vacuum cleaner system according to claim 1, wherein:
the expected characteristics comprise: an expected location, shape, and/or size of the fiducial mark within the obtained image of the surroundings.

4. The robotic vacuum cleaner system according to claim 1, wherein:
the additional information comprises one or more of:
information that the robotic vacuum cleaner is being charged by or engaged with a robotic vacuum cleaner charging station;
a location of the robotic vacuum cleaner;
a stage of a cleaning operation; and
a time.

5. The robotic vacuum cleaner system according to claim 1, wherein:
the diagnostics module is configured quantitatively to determine a deviation of a value of a characteristic of the fiducial mark in the obtained image of the surroundings from the expected value of the characteristic;
the diagnostics module is configured to compare the deviation to a predetermined threshold deviation; and
if it is determined that the determined deviation exceeds the predetermined threshold deviation, the alert generation module is configured to generate the alert.

6. The robotic vacuum cleaner system according to claim 1, wherein:
the processor further comprises:
a charging detection module configured to determine whether the robotic vacuum cleaner is being charged by the robotic vacuum cleaner charging station; or
an engagement detection module configured to determine whether the robotic vacuum cleaner is engaged with the robotic vacuum cleaner charging station;
when it is determined that the robotic vacuum cleaner is engaged with or being charged by the robotic vacuum cleaner charging station, if the diagnostics module determines that the image of the fiducial mark does not have the predetermined expected characteristics, the alert generation module is configured to generate an alert that the robotic vacuum cleaner charging station is improperly assembled.

7. The robotic vacuum cleaner system according to claim 6, wherein:
the robotic vacuum cleaner system further comprises the robotic vacuum cleaner charging station;
the robotic vacuum cleaner charging station is separable into two or more components, and includes the fiducial mark.

8. The robotic vacuum cleaner system according to claim 7, wherein:
the robotic vacuum cleaner charging station comprises:
a dock comprising:
a base arranged, in use, to contact a floor;
an engagement portion including:
a front engagement region having a first electrical contact configured to engage with a complementary second electrical contact on the robotic vacuum cleaner; and
a rear engagement region having a first connector; and
a planar backplate having:
a front surface including a second connector, the backplate being separably connected to the engagement portion of the dock by means of an engagement between the first connector and the second connector, the front surface of the planar backplate comprising the one or more fiducial marks; and
a rear surface arranged, in use, to contact a vertical wall; and
the alert that the robotic vacuum cleaner charging station is improperly assembled indicates that the backplate of the robotic vacuum cleaner charging system is not properly connected to the rear engagement region of the dock.

9. The robotic vacuum cleaner system according to claim 1, wherein:
the robotic vacuum cleaner further comprises:
a memory storing a map of a floor of the building, the map including an indication of the location of the charging station; and
a motion system;
the processor further comprises a navigation module; and
in a return operation:
the navigation module is configured to determine a route back from a current location of the robotic vacuum cleaner towards the charging station, and to generate instructions, which when received by the motion system, cause it to move the robotic vacuum cleaner towards the charging station;
the location determination module is configured to determine, based on a determined location of the robotic vacuum cleaner and the map of the floor of the building, when the robotic vacuum cleaner is located within a predetermined threshold distance of the charging station; and
the fiducial detection module is configured to detect the presence of the one or more fiducial marks on the charging station when it is determined that the robotic vacuum cleaner is within the predetermined threshold distance of the charging station.

10. The robotic vacuum cleaner system according to claim 1, wherein:
in a docking operation:
when it is determined that that robotic vacuum cleaner is located within the predetermined threshold distance of the charging station, the fiducial detection module is configured to detect whether or not the fiducial marks on the charging station are present in an image obtained by the one or more cameras.

11. The robotic vacuum cleaner system according to claim 10, wherein:
when it is determined that the fiducial marks are present in the image obtained by the one or more cameras, the fiducial detection module is configured to determine relative position information indicating a position of the robotic vacuum cleaner relative to the charging station; and
the navigation module is configured to:
determine a route from the current location of the robotic vacuum cleaner to a charging position in which the robotic vacuum cleaner is engaged with the charging station, based on the relative position information, and
generate instructions, which when received by the motion system, cause it to move the robotic vacuum cleaner to the charging position.

12. The robotic vacuum cleaner system according to claim 10, wherein:
when it is determined that the fiducial marks are not present in the image obtained by the one or more camera, the navigation module is configured to:
identify an alternative position within the predetermined threshold distance of the charging station;
determine a route from the current location of the robotic vacuum cleaner to the alternative position within the predetermined threshold distance of the charging station; and
generate instructions, which when received by the motion system, cause it to move the robotic vacuum cleaner to the alternative position within the predetermined distance threshold of the charging station; and
when it is determined that that robotic vacuum cleaner is located at the alternative position within the predetermined threshold distance of the charging station, the fiducial detection module is configured again to detect whether or not the fiducial marks on the charging station are present in an image obtained by the one or more cameras.

13. The robotic vacuum cleaner system according to claim 9, wherein:
the predetermined threshold distance is 0.5 to 2 metres.

14. The robotic vacuum cleaner according to claim 1, wherein:
when it is determined that the fiducial marks are not present in the image obtained by the one or more cameras, the robotic vacuum cleaner is configured to generate an alert.

15. The robotic vacuum cleaner according to claim 1, wherein:
at the start of a cleaning operation, when the robotic vacuum cleaner is located in a charging position in which it is engaged with the charging station, the fiducial detection module is configured to determine whether the fiducial marks are either: present in an image obtained from the one or more cameras, or present in an expected location in an image obtained from the one or more cameras; and
if the fiducial detection module determines that the fiducial marks are either not present in the image received from the one or more cameras or are not present.
